(19) United States
(12) Patent Application Publication
(10) Pub. No.: US 2014/0307472 A1
(43) Pub. Date: Oct. 16, 2014

(54) LIGHT GUIDE PLATE AND BACKLIGHT MODULE

(71) Applicant: HON HAI PRECISION INDUSTRY CO., LTD., New Taipei (TW)

(72) Inventor: YUNG-CHANG TSENG, New Taipei (TW)

(21) Appl. No.: 13/945,891

(22) Filed: Jul. 18, 2013

(30) Foreign Application Priority Data
Apr. 15, 2013 (TW) 102113336

(51) Int. Cl. F21V 8/00

(52) U.S. Cl. CPC G02B 6/0036; G02B 6/0073
USPC 362/612; 362/626

(57) ABSTRACT

A light guide plate includes a light emitting surface, a bottom surface opposite to the light emitting surface, a first side surface, a second side surface, and a light incident surface. The first side surface and the second side surface connect the light emitting surface to the bottom surface. The light incident surface is connected to the light emitting surface, the bottom surface, the first side surface, and the second side surface. A plurality of V-shaped grooves is defined in the bottom surface. The V-shaped grooves form concentric arcs, sectional surfaces of the V-shaped grooves along radial directions of the concentric arcs are isosceles triangles, and a top angle of each of the isosceles triangles is equal to about 80 degrees.

### BACKGROUND

1. Technical Field

The present disclosure relates to a light guide plate and a backlight module including the light guide plate.

2. Description of Related Art

A backlight module includes a light guide plate. The light guide plate includes a light emitting surface and a bottom surface opposite to the light emitting surface. Microdots are formed on the bottom surface. The microdots reflect light to make the light emitting from the light emitting surface. Yet, microdots reflect light to different directions, thus, when the light emits from the light emitting surface, the light is also transmitted along different directions. Thus, the backlight module also requires a brightness enhancing film with prism structures. The brightness enhancing film is used to change the transmission direction of the light to a direction substantially perpendicular to the light emitting surface. The size of the backlight module, as it includes a light guide plate and a brightness enhancing film, is big.

Therefore, it is desirable to provide a light guide plate and a backlight module having the light guide plate which can overcome the limitations described.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a backlight module according to an exemplary embodiment of the present disclosure, the backlight module includes a light guide plate.

FIG. 2 is a schematic, isometric view of the light guide plate of FIG. 1.

FIG. 3 is a schematic, side view of the light guide plate of FIG. 2.

FIG. 4 is a diagram showing distribution of luminous intensity of the light emitting from the light guide plate of FIG. 2.

### DETAILED DESCRIPTION

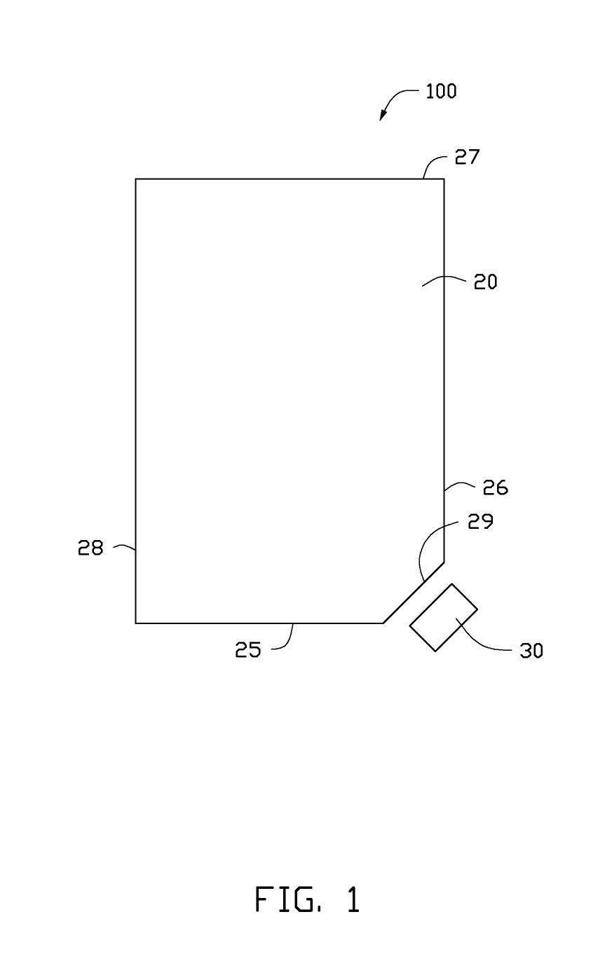

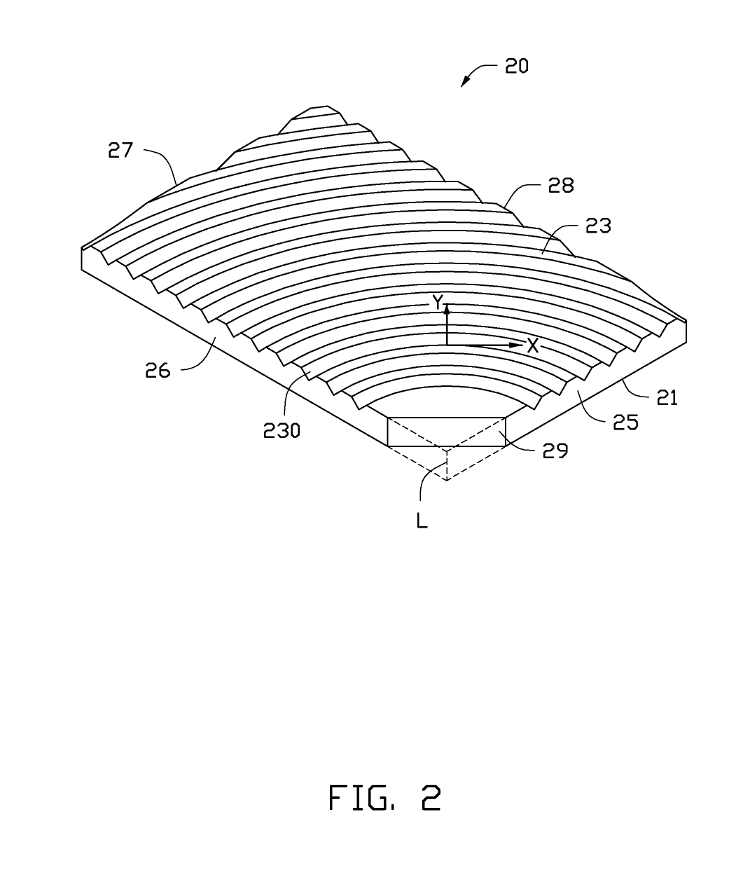

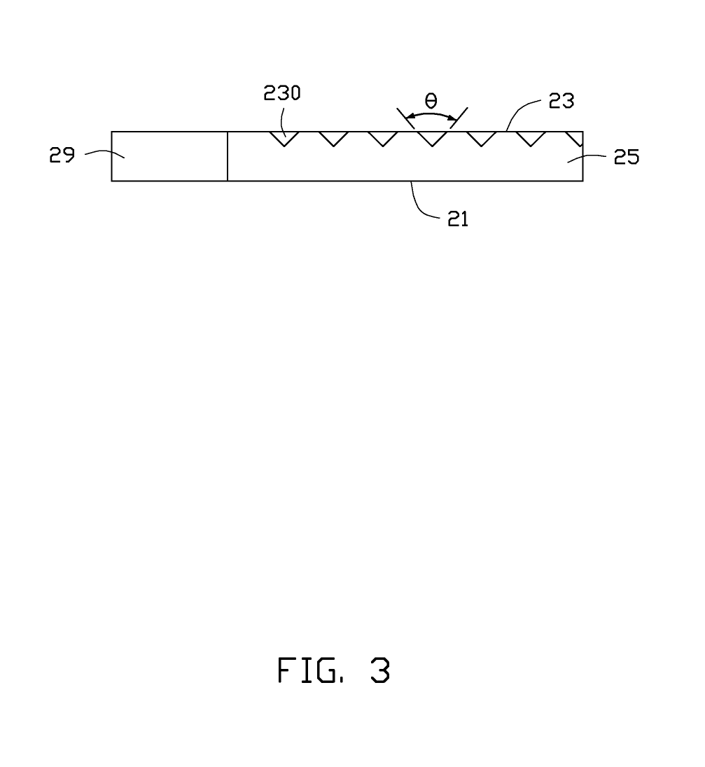

FIGS. 1-3 show a backlight module 100 according to an exemplary embodiment of the present disclosure. The backlight module 100 includes a light guide plate 20 and a light source 30. In this embodiment, the light source 30 is a light emitting diode (LED). A divergence angle of light emitted by the light source 30 is ±90 degrees.

The light guide plate 20 is made of transparent resin, such as polymethyl methacrylate (PMMA). A refraction index of the light guide plate 20 is about 1.5. The light guide plate 20 includes a light emitting surface 21, a bottom surface 23 opposite to the light emitting surface 21, a first side surface 25, a second side surface 26, a third side surface 27, and a fourth side surface 28. The first side surface 25, the second side surface 26, the third side surface 27 and the fourth side surface 28 connect the light emitting surface 21 to the bottom surface 23. The first side surface 25 is perpendicular to the second side surface 26. The first side surface 25 is opposite to the third side surface 27. The second side surface 26 is opposite to the fourth side surface 28.

The light guide plate 20 further includes a light incident surface 29. The light incident surface 29 is connected to the light emitting surface 21, the bottom surface 23, the first side surface 25, and the second side surface 26. The light source 30 faces the light incident surface 29.

A number of V-shaped grooves 230 are formed on the bottom surface 23. The V-shaped grooves 230 form concentric arcs. The center of the concentric arcs is located on an imaginary intersection line L where the first side surface 25 meets the second side surface 26. Sectional surfaces of the V-shaped grooves along radial directions Y of the concentric arcs are isosceles triangles. The isosceles triangle has a top angle θ.

The light source 30 is also positioned on the imaginary intersection line L. Light emitted from the light source 30 transmits along radial directions Y of the concentric arcs formed by the V-shaped grooves 230, and is perpendicular to tangents X of the concentric arcs. After being reflected by the V-shaped grooves 230, the light is also perpendicular to the tangents X.

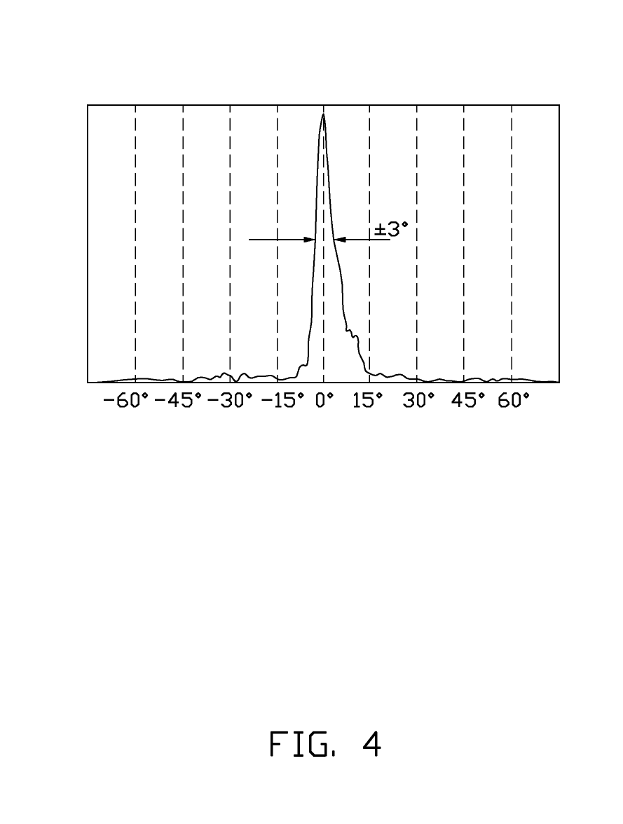

Divergence angles of the light reflected by the V-shaped grooves 230 along radial directions Y of the concentric arcs vary when the top angles θ vary. FIG. 4 shows distribution of luminous intensity of the light emitting from the light emitting surface 21 when the top angles θ are equal to about 80 degrees. In FIG. 4, the horizontal axis represents an angle between the transmission direction of the light and a normal line of the light emitting surface 21, and the vertical axis represents the luminous intensity. FIG. 4 shows that when the top angles θ are equal to about 80 degrees, the light are substantially transmitted along the normal line of the light emitting surface 21 and the full width at half maximum (FWHM) of the divergence angles of the light is only ±3 degrees.

The present invention uses the V-shaped grooves 230 to replace the microdots. The V-shaped grooves 230 reflect light to a direction perpendicular to the light emitting surface 21. There is no need for a brightness enhancing film and the size of the backlight module is reduced.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

What is claimed is:

1. A light guide plate comprising:
a light emitting surface;
a bottom surface opposite to the light emitting surface;
a first side surface and a second side surface both connecting the light emitting surface to the bottom surface;
a light incident surface connected to the light emitting surface, the bottom surface, the first side surface, and the second side surface; and
a plurality of V-shaped grooves defined in the bottom surface, wherein the V-shaped grooves form concentric arcs, a sectional surface of each of the V-shaped grooves along a radial direction of the concentric arcs is an isosceles triangle, a top angle of the isosceles triangle is equal to about 80 degrees.

2. The light guide plate of claim 1, wherein the first side surface is perpendicular to the second side surface.

3. The light guide plate of claim 2, wherein centers of the concentric arcs are positioned at an imaginary intersection line where the first side surface meets the second side surface.

4. A backlight module comprising:
a light guide plate comprising:
a light emitting surface;
a bottom surface opposite to the light emitting surface;
a first side surface and a second side surface connecting the light emitting surface to the bottom surface;
a light incident surface connected to the light emitting surface, the bottom surface, the first side surface, and the second side surface; and
a plurality of V-shaped grooves defined in the bottom surface, wherein the V-shaped grooves form concentric arcs, a sectional surface of each of the V-shaped grooves along a radial direction of the concentric arcs is an isosceles triangle, a top angle of the isosceles triangle is equal to about 80 degrees; and
a light source facing the light incident surface.

5. The backlight module of claim 4, wherein the first side surface is perpendicular to the second side surface.

6. The backlight module of claim 5, wherein centers of the concentric arcs are positioned at an imaginary intersection line where the first side surface meets the second side surface.

7. The backlight module of claim 4, wherein the light source is a light emitting diode.
